(19) United States
(12) Patent Application Publication
(10) Pub. No.: US 2015/0329349 A1
(43) Pub. Date: Nov. 19, 2015

(54) FUEL DISPENSER SYSTEM WITH SEALED PARTITION PART

(71) Applicant: Wayne Fueling Systems Sweden AB, Malmo (SE)

(72) Inventors: Bengt I. Larsson, Malmo (SE); Eva-Lie Edvardsson, Malmo (SE)

(21) Appl. No.: 14/278,983

(22) Filed: May 15, 2014

(51) Int. Cl. B67D 7/84; F17C 5/06; F17C 5/02; B67D 7/04

(52) U.S. Cl. CPC B67D 7/84; B67D 7/04; F17C 5/06; F17C 5/02; F17C 2221/033; F17C 2265/065; F17C 2205/0302

(57) ABSTRACT

A fuel dispenser system is provided including a partition part to separate a fuel dispensing unit from at least one electrically powered component. The partition part can be configured and arranged to seal the at least one electrically powered component from exposure to gas vapors emitted from the fuel dispensing unit. The fuel dispenser unit can include a fuel dispensing nozzle and a hydraulic component. The system can include additional fuel dispensing units. The fuel dispensing nozzle can be configured to dispense CNG, and the additional fuel dispensing nozzle can be configured to dispense CNG or another type of fuel. The at least one electrically powered component may include a transaction terminal.

### FIELD

The subject matter disclosed herein relates to fuel dispensers, and in particular, dispensers that can dispense Compressed Natural Gas (CNG).

### BACKGROUND

Many commercial and industrial sites are commonly classified as hazardous environments due to risk of explosion or fire. Areas involving fuel-dispensing equipment, for example, are classified as hazardous due to the types of products handled by these dispensers. A well-defined classification system for such hazardous environments has been developed, and equipment can be rated to operate in various environment classes. In one such system, areas where ignitable concentrations of flammable gases, flammable liquid-produced vapors, or combustible liquid-produced vapors can exist under normal operating conditions and/or where hazard is caused by frequent maintenance or repair work or frequent equipment failure are classified as Class I, Division 1. One such environment is the inside of the hydraulic cabinet of a gasoline dispenser. In such environments, electronics are required to be “explosion proof” or “intrinsically safe,” meaning that they cannot create a spark capable of ignition even in the case of a fault of electronics.

Areas where ignitable concentrations of flammable gases, flammable liquid-produced vapors, or combustible liquid-produced vapors are not normally present, but may exist due to an accidental rupture or breakdown, are classified as Class I, Division 2. This typically includes areas adjacent to Class I, Division 1 areas. The immediate area around a dispenser would be an example of such an area. Electronics used in this area are required to not be able to produce a spark capable of ignition under normal operating conditions.

The type of fuel dispensed determines the classification of the hazardous zones in and around the dispenser. Fuels with vapors that are heavier than air differ from those with properties that are lighter than air and thus create different zones. For example, CNG is lighter than gasoline/diesel vapor and behaves differently. As such, CNG dispensers must meet different (more stringent) safety requirements than, for example, gasoline or diesel dispensers.

Electronics must be designed to meet the requirements of the zone in which they will reside. In some cases this can be expensive (e.g., the design of Intrinsically Safe Barriers or Explosion-proof boxes) and, in still other cases, it may be difficult to design or protect the electronics so as to perform the desired function while meeting the zone requirements (e.g., the design of a receipt printer to be used in a Class I, Division 1 area).

Natural gas is considered to be a greener energy source than gasoline due to its lower emission profile. Its adaptation, however, has been relatively slow due to a lack of distribution network. Whereas gasoline stations are nearly ubiquitous, natural gas (e.g., CNG or Liquefied Natural Gas (LNG)) fueling stations are sparse. One reason for this is due to the high cost required to implement natural gas dispensers, which requires, for example, specially designed electronics as discussed above.

To avoid the high cost of electronics specially designed to meet the environment requirements, some current CNG dispensers are physically separated from dispensers of other fuels such as gasoline, diesel, or additives. Some current CNG dispensers exclude electronics, such as payment/media terminal. Some current CNG dispensers require venting around the electronic module, for example, at the payment terminal.

Accordingly, there remains a need for a dispenser system that can utilize cheaper electronics that are not specially designed for operation in a classified hazardous environment while being safely deployed in such an environment. There is also a need for a combined fuel dispensing system that can dispense more than one type of fuel.

### BRIEF DESCRIPTION

Dispenser systems and methods are provided in which the electronics are sealed from potential exposure to hazardous conditions such as fuel vapors. Such a system can enable the use of more widely available electronics in a hazardous environment. Such a system can also enable existing fuel dispenser systems to be upgraded to dispense additional fuel types by allowing the existing electronics to safely work in the additionally hazardous environment. This could lower the cost of implementing, for example, natural gas fuel stations, and could accelerate the adaptation of cleaner energy sources. Moreover, the fuel dispenser systems disclosed herein can increase the efficiency, longevity, and safety of electronics operating within a hazardous environment. Such systems can have particular utility in fuel dispensing applications, such as dispensers for gasoline, CNG, LNG, and diesel, but can also be applied broadly to any application where it is necessary to reduce the risk of fire or explosion caused by electrical components in a hazardous environment.

In one aspect, a fuel dispensing system is provided. The fuel dispenser system can include at least one electrically powered component housed in a housing, a fuel dispensing unit including a nozzle and a hydraulic component, and a partition part arranged between the fuel dispensing unit and the at least one electrically powered component. The partition part can configured and arranged to seal the at least one electrically powered component from exposure to gas vapors emitted from the fuel dispensing unit. The system can further include one or more additional fuel dispensing units for dispensing one or more types of fuel.

In some embodiments, the at least one electrically powered component is not rated for operation in a hazardous area. In some embodiments, the fuel dispensing unit dispenses CNG, and the at least one electrically powered component may not be rated for operation with CNG. In some embodiments, the partition part can have a width to space the fuel dispensing unit, for example, horizontally at a distance away from the housing or enclosure containing the at least one electrically powered component. The width may be, for example, at least 200 mm. In some embodiments, the partition part can have a coffin shape, and/or may form a hermetic seal with the housing of the at least one electrically powered component. By way of non-limiting example, the partition part can be a gas impermeable material. In some embodiments, the partition part defines one or more recesses to accommodate a nozzle.

In some embodiments, the at least one electrically powered component can be a payment terminal. The payment terminal can include, for example, a display and/or a printer.

As explained in more detail below, such a system can also include a number of other features and/or modifications.

In another aspect, a method of dispensing a fuel is provided. The method can include providing at least one electrically powered component housed in a housing, providing a fuel dispensing unit, and providing and arranging a partition part between the fuel dispensing unit and the at least one electrically powered component. The partition part can be configured and arranged to seal the at least one electrically powered component from exposure to gas vapors emitted from the fuel dispensing unit.

In some embodiments, the at least one electrically powered component is not rated for operation in a hazardous area. In some embodiments, the method can further include providing a further fuel dispensing unit. In some embodiments, the fuel dispensing unit dispenses CNG and the at least one electrically powered component is not rated for use in a CNG environment.

### BRIEF DESCRIPTION OF THE DRAWINGS

These and other features will be more readily understood from the following detailed description taken in conjunction with the accompanying drawings, in which:

FIG. 1 is an illustration of one embodiment of a fuel dispenser system;

FIG. 2 is an illustration of another embodiment of a fuel dispenser system;

FIG. 3 is an isolation view of the sealed partition part shown in FIG. 2;

FIG. 4 is an illustration of yet another embodiment of a fuel dispenser system; and

FIG. 5 is an isolation view of the sealed partition part shown in FIG. 4.

It is noted that the drawings are not necessarily to scale. The drawings are intended to depict only typical aspects of the subject matter disclosed herein, and therefore should not be considered as limiting the scope of the disclosure. In the drawings, like numbering represents like elements between the drawings.

### DETAILED DESCRIPTION

Certain exemplary embodiments will now be described to provide an overall understanding of the principles of the structure, function, manufacture, and use of the devices, systems, and methods disclosed herein.

Fuel dispenser systems are provided that can utilize non-specialized electronics (e.g., existing/standard electronics designed for dispenser systems of different or less hazardous fuel) while complying with the requirements for use in an environment classified as hazardous due to the presence of explosive gases. Such systems can be used, for example, to protect and allow for the use of electronic components that are otherwise not rated or designed for use in the hazardous environment. For example, the systems described herein can include a nozzle for dispensing CNG while utilizing electronics that are not specially designed for such a hazardous environment.

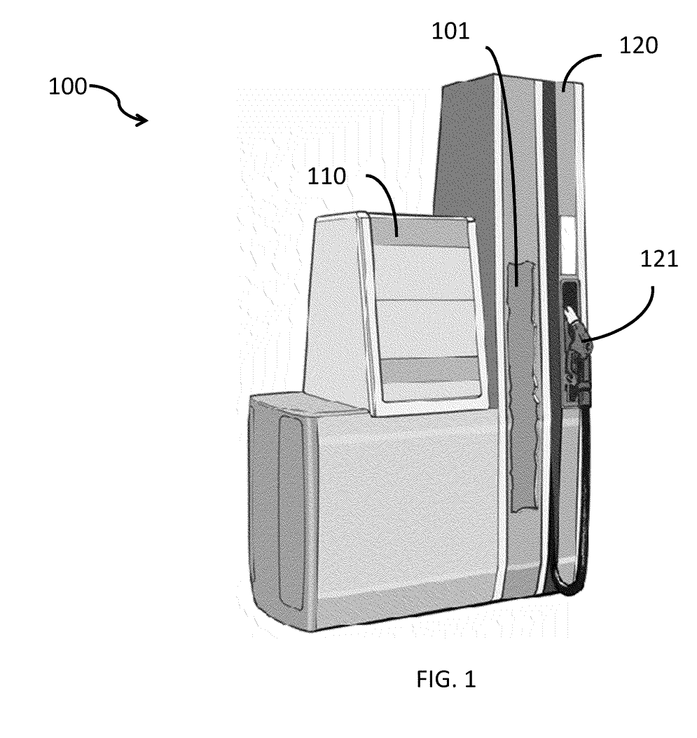

FIG. 1 illustrates one embodiment of a fuel dispenser system. System 100 generally includes a housing which houses an electronics module 110 and other internal components (not shown). The electronics module 110 can be in the form of a housing containing various electronics, including one or more of, for example, a processor, computer memory, display, input device such as a keypad, credit card and/or cash receiver, printer, and other electrically powered components. System 100 also includes a CNG module 120, a CNG nozzle 121, and a sealed partition part 101 between the electronics module 110 and the CNG module 120. The sealed partition part 101 is disposed within the housing (as shown for illustration purposes by the cutaway in the housing), and the part 101 is configured and arranged to separate and seal (protect) the electronics module 110 from the CNG module. For example, in some embodiments, the sealed partition part is configured to prevent the electronics module 110 from being exposed to the gas vapors that may be emitted from the CNG module/nozzle. In some embodiments, the sealed partition part provides a hermetic seal in the housing to act as a barrier from exposing internal electrical components of the electronics module 110 to any gas vapors.

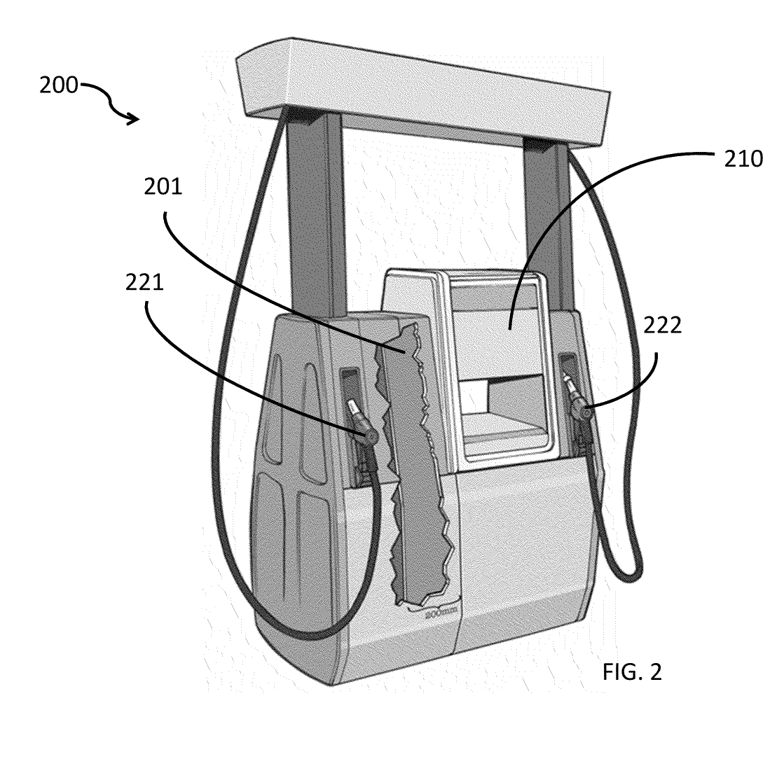

FIG. 2 illustrates another embodiment of a fuel dispenser system. System 200 generally includes a housing that houses an electronics module 201 and other internal components (not shown). A CNG nozzle 221 is positioned on one side of the housing, and a sealed partition part 201 is located inside the housing (as shown for illustration purposes by the cutaway in the housing) between the CNG nozzle 221 and the electronics module 210. On the other side of the electronics module 201, the system includes a fuel nozzle 222 for dispensing another type of fuel such as gasoline or diesel. In some embodiments, the electronics module 201 may be selected from a design that is compatible with fuel nozzle 222 for dispensing, for example, gasoline or diesel. Since gasoline and diesel dispensers are ubiquitous, such electronics module are readily available. By providing the sealed partition part 201 that seals the electronics module 210 from potentially hazardous conditions associated with nozzle 221 (such as vapors emitted therefrom), the electronics module 210 does not need to be specially designed or constructed to meet the requirements of such hazardous environment. In some embodiments, the partition part 201 separates CNG hydraulic components from the part of the dispenser that contains the electronics module 210.

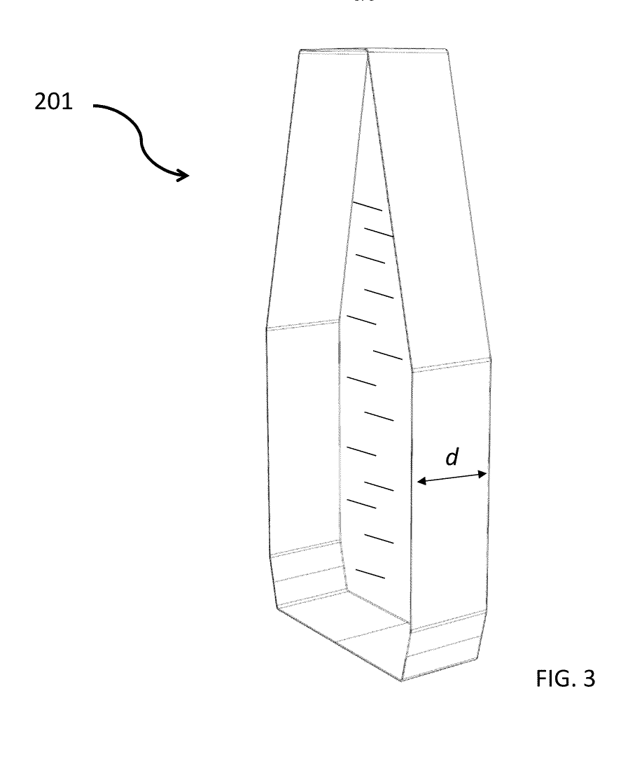

FIG. 3 shows sealed partition part 201 in isolation. As shown, partition part 201 can have the shape that matches the shape of the dispenser system. In this embodiment, partition part 201 has the shape of a coffin, e.g., with eight sides. In some embodiments, partition 201 can have a depth d of at least in the range of 100 to 300 mm, and more preferably of about 200 mm, which is particularly useful for CNG dispenser applications. Partition part 201 can have a solid volume. Alternatively, partition part 201 can have a hollow core with left and right side walls that form an enclosed cavity, or with only one of the left and right side walls being present such that the partition part 201 is open on one side only as shown. In some embodiments, partition part 201 can be formed from or include a fire retardant material and/or a material that is impermeable to gas vapors (e.g., CNG, gasoline, diesel, etc.). The partition part can also be configured in different shapes and sizes depending on the dispenser system and the requirements.

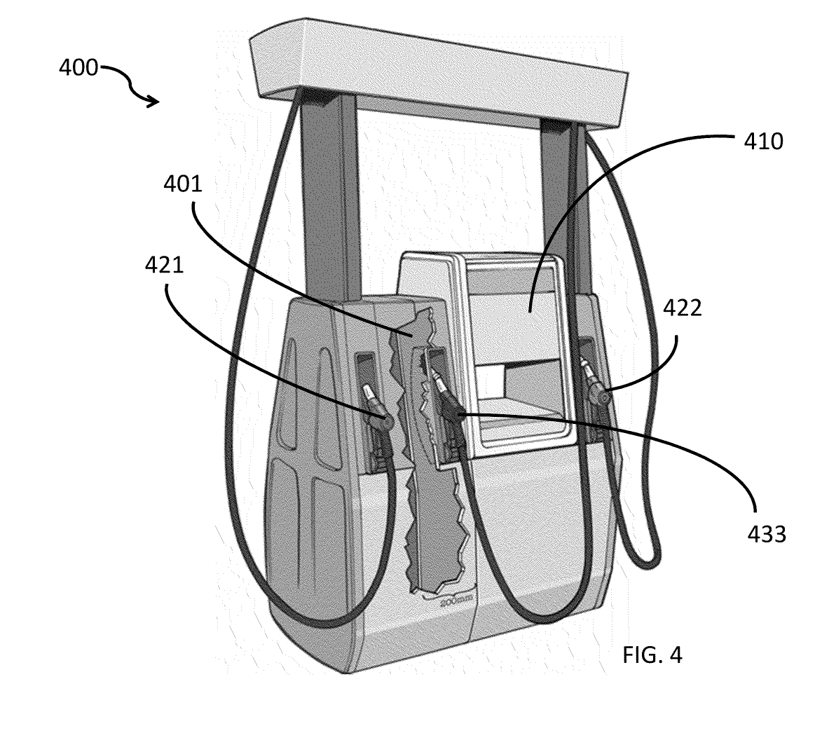

FIG. 4 shows yet another embodiment of a fuel dispenser system 400 that is similar to the system shown in FIG. 2, except that in this embodiment the system includes an additional nozzle 433 provided between partition part 401 and electronics 410. To accommodate nozzle 433, partition part 401 is provided with a recess for receiving (at least partially) nozzle 433.

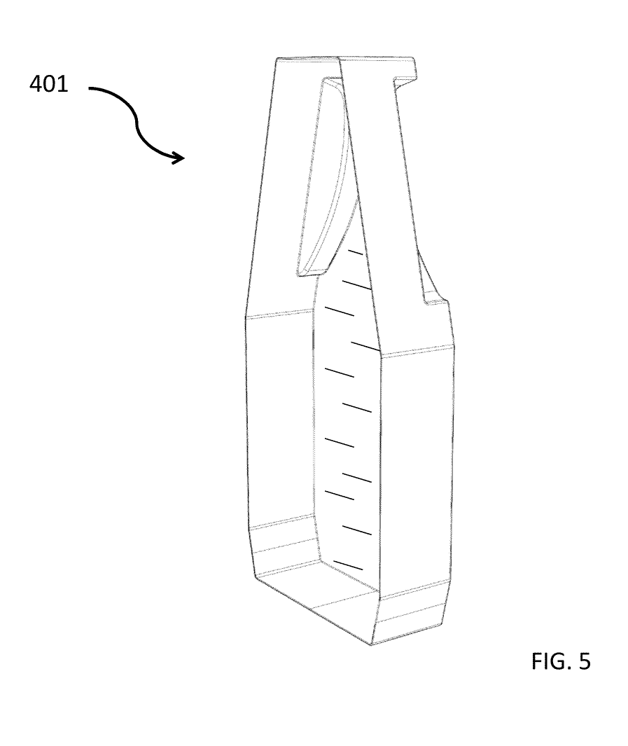

FIG. 5 shows partition part 401 of FIG. 4 in isolation. As can be seen, partition part 401 can be provided with multiple recesses to accommodate multiple nozzles (for example, one on each side of the system 400). In other embodiments, partition part 401 can have other shapes and/or sizes to accommodate different nozzles or to conform to the configuration of the dispenser system.

In some embodiments, one or more components of the fuel dispensing system can be modular. For example, a nozzle can be part of a dispensing module, which can be replaced by another dispensing module to dispense, for example, a different type of fuel. The partition part can also be configured as a module so that it can be, for example, interchanged with other modules. In some embodiments, a plurality of partition parts can be provided and arranged in different configurations. For example, in some embodiments, a plurality of partition parts can be placed next to each other in order to form a stronger and/or thicker barrier. In some embodiments, partition parts can be deployed on different sides of the electronics (e.g., one on each side) depending on the desired configuration.

In some embodiments, the partition part(s) can be added to existing gasoline and/or diesel dispensing systems to allow those systems to dispense natural gas (e.g., instead of or in addition to the previous fuel) without the need to replace some or all of the electronics.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A fuel dispenser system, comprising:
at least one electrically powered component housed in a housing;
a fuel dispensing unit including a nozzle and a hydraulic component; and
a partition part arranged between the fuel dispensing unit and the at least one electrically powered component, the partition part being configured and arranged to seal the at least one electrically powered component from exposure to gas vapors emitted from the fuel dispensing unit.

2. The system of claim 1, wherein the at least one electrically powered component is not rated for operation in a hazardous area.

3. The system of claim 1, further comprising an additional fuel dispensing unit.

4. The system of claim 1, wherein the fuel dispensing unit dispenses compressed natural gas.

5. The system of claim 4, wherein the at least one electrically powered component is not rated for operation with compressed natural gas.

6. The system of claim 3, wherein the fuel dispensing unit dispenses compressed natural gas and the additional fuel dispensing unit dispenses another type of fuel.

7. The system of claim 1, wherein the partition part has a width to space the fuel dispensing unit at a distance away from the at least one electrically powered component.

8. The system of claim 1, wherein the partition part has a coffin shape.

9. The system of claim 1, wherein the partition part forms a hermetic seal with the housing of the at least one electrically powered component.

10. The system of claim 1, wherein the partition part comprises a gas impermeable material.

11. The system of claim 1, wherein the partition part defines one or more recesses to accommodate a nozzle.

12. The system of claim 1, further comprising one or more different fuel dispensing units for dispensing a plurality of fuel types.

13. The system of claim 1, wherein the at least one electrically powered component comprises a payment terminal.

14. The system of claim 13, wherein the payment terminal comprises a display and a printer.

15. The system of claim 1, wherein the partition part separates the fuel dispensing unit and the at least one electrically powered component in a horizontal relation.

16. The system of claim 15, wherein the partition part has a width of at least 200 mm to separate the fuel dispensing unit at least 200 mm away from the housing containing the at least one electrically powered component horizontally.

17. A method of dispensing a fuel, comprising:
providing at least one electrically powered component housed in a housing;
providing a fuel dispensing unit having a nozzle and a hydraulic component; and
providing and arranging a partition part between the fuel dispensing unit and the at least one electrically powered component, the partition part being configured and arranged to seal the at least one electrically powered component from exposure to gas vapors emitted from the fuel dispensing unit.

18. The method of claim 17, wherein the at least one electrically powered component is not rated for operation in a hazardous area.

19. The method of claim 17, further comprising providing a further fuel dispensing unit.

20. The method of claim, wherein the fuel dispensing unit dispenses compressed natural gas and the at least one electrically powered component is not rated for use in a compressed natural gas environment.
